(19) United States
(12) Patent Application Publication
(10) Pub. No.: US 2015/0356174 A1
(43) Pub. Date: Dec. 10, 2015

(54) SYSTEM AND METHODS FOR CAPTURING AND ANALYZING DOCUMENTS TO IDENTIFY IDEAS IN THE DOCUMENTS

(71) Applicant: WIPRO LIMITED, Bangalore (IN)

(72) Inventors: Vinay Narayana, Bangalore (IN); Santhosh Kumar Maniyan, Palakkad (IN); Sarayu Kosanam, Krishna District (IN); Manoj Madhusudhanan, Bangalore (IN); Ramprasad Kanakatte Ramanna, Bangalore (IN)

(21) Appl. No.: 14/338,814

(22) Filed: Jul. 23, 2014

(30) Foreign Application Priority Data
Jun. 6, 2014 (IN) 2782/CHE/2014

(51) Int. Cl. G06F 17/30

(52) U.S. Cl. CPC G06F 17/30705; G06F 17/30011

(57) ABSTRACT

Systems and methods for capturing and analyzing documents to identify ideas in the documents are described herein. In one example, the method for capturing and analyzing documents to identify ideas in the documents comprises pre-processing the documents to remove noise, and extracting a theme associated with each of the documents, based on distribution of words and phrases in the documents. The method further comprises performing labelling of the documents by assigning a topic to each of the documents, based on pre-defined labelling rules and theme of the documents; and clustering the labelled documents into a plurality of groups based on similarity of the topics assigned to each of the documents.

This application claims the benefit of Indian Patent Application Serial No. 2782/CHE/2014, filed Jun. 6, 2014, which is hereby incorporated by reference in its entirety.

### TECHNICAL FIELD

The present subject matter is related, in general to the field of data processing and, in particular, but not exclusively to a method and system for capturing and analyzing documents to identify ideas in the documents.

### BACKGROUND

In recent times, there has been a continuous and rapid growth of the volume and scope of textual information available on the Internet and on internal networks. This makes the identification of documents of interest to a particular person or organization very challenging. Generally, a user seeking documents of interest enters various keywords or phrases (also known as a search phrase) in a query which is then executed on a repository of data or documents. The execution of the query facilitates identification of documents that match the keywords or phrases entered by the user. However, identifying documents in such a manner imposes a burden on the user to provide specific query seeking data. Furthermore, the documents identified by such a search may not be relevant or of interest to the user since the search only attempts to match the search phrase entered by the user with the document content and not according to the context of the document.

It will also be apparent to the readers that most of the documents have natural language contents. Hence, one of the challenges in processing the documents is handling the “unstructured data”, i.e., information that either does not have a pre-defined data model or is not organized in a pre-defined manner. Usually, a document collection in its natural state is unorganized, or in a so-called unstructured state. Examples of such documents can include Web pages scattered over the Internet, documents in a company or other organizations, and documents on personal computers.

In recent years many techniques have been developed to organize and determine the amount and relevancy of the information in natural language contents of the documents. Conventional techniques include search engines and document classification systems. In search operations, information in the unstructured document data is accessed by sending queries to a search engine or index server that returns the documents believed to be relevant to the query. One problem with using queries to access unknown data is that the users often do not know what information is contained in the documents. Thus, in many cases, users are not able to come up with the right key words to effectively retrieve the most relevant information or document.

### SUMMARY

Disclosed herein are systems and methods for capturing and analyzing documents to identify ideas in the documents. In one example, the topic capture and analysis (TCAA) system, for capturing and analyzing documents to identify ideas in the documents comprises a processor, a memory communicatively coupled to the processor, wherein the memory stores processor-executable instructions, which, on execution, cause the processor to pre-process the documents to remove noise, and extract a theme associated with each of the documents, based on distribution of at least one of words and phrases in one or more of the documents. The processor-executable instructions further causes the processor to perform labelling of the documents by assigning a topic to each of the documents, based on pre-defined labelling rules and theme of the documents, and cluster the labelled documents into a plurality of groups based on similarity of the topics assigned to each of the documents.

In an aspect of the invention, the method, for capturing and analyzing documents to identify ideas in the documents, comprises pre-processing the documents to remove noise, and extracting a theme associated with each of the documents, based on distribution of words and phrases in the documents. The method further comprises performing labelling of the documents by assigning a topic to each of the documents, based on pre-defined labelling rules and theme of the documents; and clustering the labelled documents into a plurality of groups based on similarity of the topics assigned to each of the documents.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a network environment implementing a topic capture and analysis (TCAA) system, for capturing and analyzing documents, according to some embodiments of the present subject matter.

FIG. 2 illustrates an exemplary computer implemented method for capturing and analyzing documents to identify ideas in the documents, according to some embodiments of the present subject matter.

FIG. 3(A) and FIG. 3(B) illustrate exemplary sub-processes associated with the exemplary computer implemented method for capturing and analyzing documents to identify ideas in the documents, according to some embodiments of the present subject matter.

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods for capturing and analyzing documents to identify ideas in the documents are described herein. The systems and methods may be implemented in a variety of computing systems. The computing systems that can implement the described method(s) include, but are not limited to a server, a desktop personal computer, a notebook or a portable computer, a mainframe computer, and in a mobile computing environment. Although the description herein is with reference to certain computing systems, the systems and methods may be implemented in other computing systems, albeit with a few variations, as will be understood by a person skilled in the art.

In recent years the capability of users or organizations to generate and/or collect large volume of electronic documents has increased dramatically as the internet facilitates publication and sharing of documents and the cost of mass storage has decreased. These documents may be in form of blog posts, posts on social networking sites, tweets, articles, whitepapers and so on. A lot of times users and interested in obtaining a summary of the topics being discussed in a large collection of documents. In other cases, the users may wish to drill down on specific topics of interest to identify further details such as the source of the document or the author or other related documents. For example in a large organization an engineer engaged in product development may be interested in studying the patent landscape or articles in technical journals related to a proposed product to establish freedom to operate or to identify new opportunities. In yet another example a marketing personnel or public relations manager in the organization may wish to study collections of documents obtained from media (including social networking sites) to understand how the organization is being viewed and discussed by a target audience.

In today's world, organizations are trying to record, capture and develop ideas in many informal and formal exchanges between its employees, customers, and vendors that lead to creation and recording of electronic documents. Often, many ideas or potentially business relevant ideas are embedded, implicit and hidden in such electronic documents.

The ideas in a document are generally defined in form of topics. Topics may be understood to be subjects or themes that can be used to categorize a document. Usually, a document may include several topics. For example, a document about the “Oklahoma City Bombing in 1995” can be said to contain topics “Bombings”, “Terrorism”, “Oklahoma”, “Deaths and Injuries”. The cost of resources involved in human annotation of such topics for a large number of documents is very high.

Many conventional techniques for extracting themes from documents have been developed. These conventional techniques usually involve word disambiguation by clustering words (noun and verb pairs) by themes. Some conventional techniques, such as the ITERATE algorithm, clusters documents into a hierarchical conceptual cluster tree based on inter-document similarity. Most of the conventional techniques for extracting themes from documents are targeted at specific applications e.g., word disambiguation, document categorization and document summarization. However, using the conventional techniques of discovering topics in a collection of documents have limited success due to inaccuracy and limited scope for engaging community to collaborate and grow an idea.

The present subject matter discloses systems and methods for capturing and analyzing documents to identify ideas in the documents. In one implementation, a topic capture and analysis (TCAA) system for capturing and analyzing documents to identify ideas in the documents, is implemented. The TCAA system may be implemented in a variety of computing systems, such as a laptop computer, a desktop computer, a notebook, a workstation, a server, a network server, a tablet and the like. In one implementation, the TCAA system may be included within an existing information technology infrastructure of an organization. For example, the TCAA system may be interfaced with the existing content and document management system(s), database and file management system(s), of the organization.

In operation, the TCAA system receives documents from one or more data sources. The documents may be structured document or unstructured document and may include, in addition to text, multimedia content, such as images, audio, video, flash and so on. These documents may be received from various classes of data sources, such as blogs, posts on social networking sites, whitepapers available over the Internet, tweets, articles available on websites (including news websites) in the form of webpages, Rich Site Summary (RSS) feeds and so on. The TCAA system then pre-processes the documents to remove noise. In one implementation, the pre-processing of documents may involve erasing infrequent words which occur below a pre-defined threshold number of times, removal of stop-words, and stemming, which reducing inflected or derived words to their stem, base or root form.

The TCAA system then extracts the theme of each of the documents based on various pre-defined processing rules, such as the probability and distribution of words and phrases within the documents and so on. Thereafter, the TCAA system performs labelling of the documents, based on pre-defined labeling rules, by assigning a topic to each of the documents. In certain cases, a single document may be assigned multiple topics. For example, a document on elections in India may be tagged with topics, such as democracy, India, name of the candidates, constituency covered, and elections.

In a parallel or sequential operation, the TCAA system may perform a trend analysis in the received documents to determine trending topics. In one example, the trend analysis of the labelled documents is performed based on distribution of topics. The trend analysis facilitates the stakeholders to identify topics which are of interest to the users and are often referred to as “hot topics”. The trend analysis also facilitates the stakeholders to identify opportunities or risks of the organization based on the issues or objects in which the users are interested in.

Thereafter, the TCAA system clusters the labelled documents into generic clusters based on pre-defined knowledge & learning models. The pre-defined knowledge & learning models are indicative of the topics which are related, and provide the basis on which related topics are identified. In one example, a document may be clustered into more than one generic cluster. Thereafter, the TCAA system determined relationships amongst the labelled documents based on pre-defined relationship models.

In one example, the TCAA system also processes the relationship(s) and the labelled documents, based on business rules, to determine business relevant ideas. In one example, the TCAA system may identify the documents which focus on topics which represent opportunities or threats to the organization as business relevant ideas.

In some embodiments, the TCAA system may also process the labeled documents to generate an abstract for the labeled documents. In one example, the TCAA system may identify a few of the most relevant sentences or phrases in the document and paraphrase the same to generate an abstract for the document. In one example, the TCAA system may determine the most significant sentences or phrases in the document based on the distribution of words and phrases and paraphrase the significant sentences as the abstract of the document. In another example, the TCAA system may compute the importance of words of the document using various scoring techniques and then combine the scores to classify a word as important or not important. The TCAA system may then identify significant sentences of the document based on the important words that a sentence contains and select significant sentences as an abstract of the document.

Thus, the TCAA system implements an integrated system to capture and analyze documents to extract ideas present in the documents. The TCAA system may be implemented within an organization or on the internet for crowd sourced ideas. The TCAA system also facilitates discovering ideas relevant to business of the organization and connecting the related ideas and people to further develop or refine the ideas.

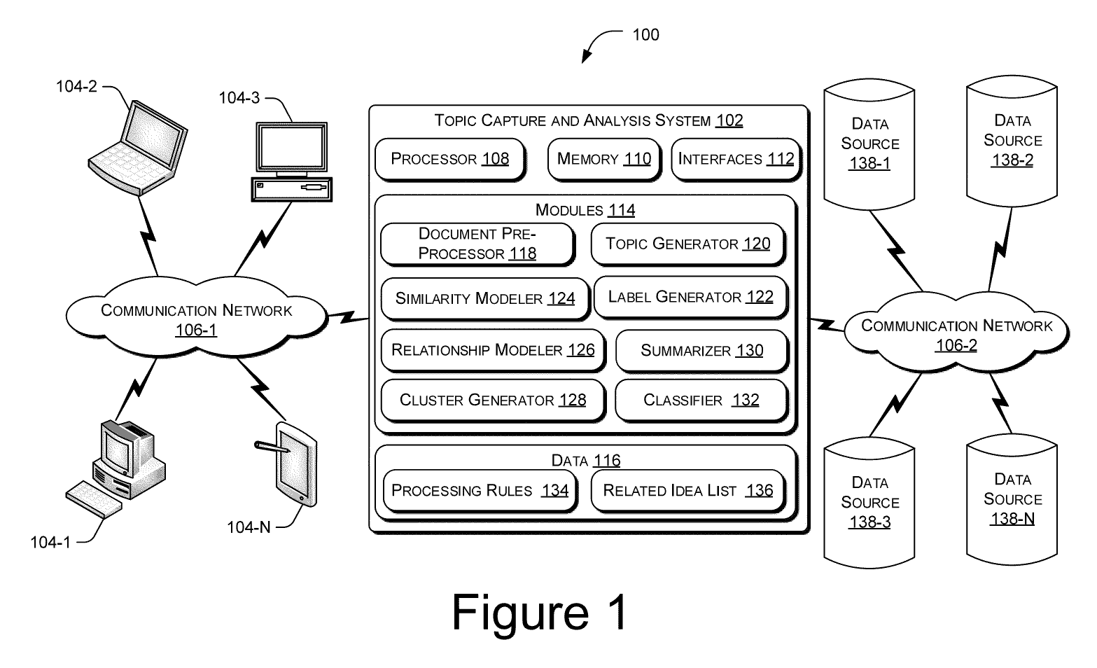

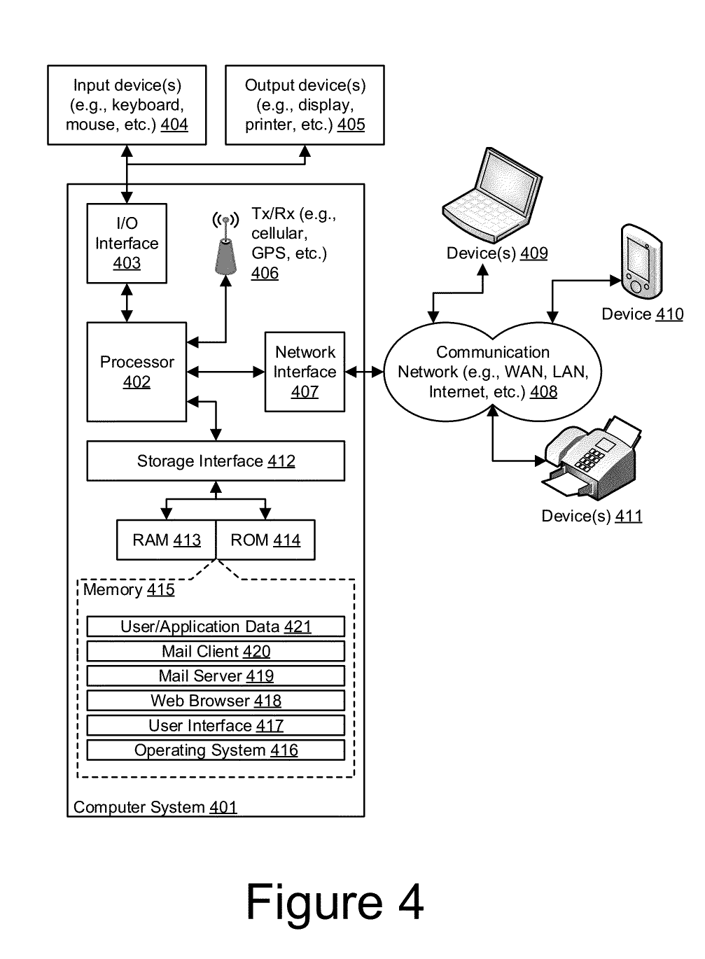

The working of the systems and methods for capturing and analyzing documents to identify ideas in the documents is described in greater detail in conjunction with FIGS. 1-4. It should be note that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a network environment 100 implementing a topic capture and analysis (TCAA) system 102 for capturing and analyzing documents to identify ideas in the documents, according to some embodiments of the present subject matter.

The TCAA system 102 may be implemented in a variety of computing systems, such as a laptop computer, a desktop computer, a notebook, a workstation, a server, a network server, a tablet and the like. In one implementation, the TCAA system 102 may be included within an existing information technology infrastructure of an organization. For example, the TCAA system 102 may be interfaced with the existing content and document management system(s), database and file management system(s), of the organization.

It will be understood that the TCAA system 102 may be accessed by users through one or more client devices 104-1, 104-2, 104-3, 104-N, collectively referred to as client devices 104. Examples of the client devices 104 include, but are not limited to, a desktop computer, a portable computer, a mobile phone, a handheld device, a workstation. The client devices 104 may be used by various stakeholders or end users of the organization, such as project managers, departmental heads and administrative heads.

As shown in the figure, such client devices 104 are communicatively coupled to the TCAA system 102 through a network 106-1 for facilitating one or more end users to access and/or operate the TCAA system 102. In some examples, the TCAA system 102 is connected to various sources of documents, such as the data source 138-1, 138-2, 138-3, . . . 138-N. The data sources 138-1, 138-2, 138-3, . . . 138-N are henceforth collectively referred to as the data sources 138. The documents, provided by the data sources 138, may be unstructured documents like text document, semi structured documents like HyperText Markup Language (HTML) files, or fully structured documents like Extensible Markup Language (XML) file. The documents may also contain files of various formats, such as image files, audio files, and video files. The data sources 138 may be understood to include blogs, posts from social networking websites, tweets, white-papers hosted on websites, news articles, and so on. In one example, the TCAA system 102 is communicatively coupled to the data sources 138 over a network 106-2. In one example, the network 106-1 and the network 106-2 may be structurally and functionally the same whereas in other examples, the network 106-1 and the network 106-2 may vary in either the structure or the function or in both. In another example the network 106-1 and the network 106-2 may be the same.

The network 106-1 and the network 106-2 may be a wireless network, wired network or a combination thereof. The network 106-1 and the network 106-2 can be implemented as one of the different types of networks, such as intranet, local area network (LAN), wide area network (WAN), the internet, and such. The network 106-1 and the network 106-2 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106-1 and the network 106-2 may include a variety of network devices, including routers, bridges, servers, computing devices, storage devices, etc.

In one implementation, the TCAA system 102 includes a processor 108, a memory 110 coupled to the processor 108 and interfaces 112. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions stored in the memory 110. The memory 110 can include any non-transitory computer-readable medium known in the art including, for example, volatile memory (e.g., RAM), and/or non-volatile memory (e.g., EPROM, flash memory, etc.).

The interface(s) 112 may include a variety of software and hardware interfaces, for example, a web interface, a graphical user interface, etc., allowing the TCAA system 102 to interact with the client devices 104 and/or the data sources 138. Further, the interface(s) 112 may enable the TCAA system 102 respectively to communicate with other computing devices, The interface(s) 112 can facilitate multiple communications within a wide variety of networks and protocol types, including wired networks, for example LAN, cable, etc., and wireless networks such as WLAN, cellular, or satellite. The interface(s) 112 may include one or more ports for connecting a number of devices to each other or to another server.

In one example, the TCAA system 102 includes modules 114 and data 116. In one embodiment, the modules 114 and the data 116 may be stored within the memory 110. In one example, the modules 114, amongst other things, include routines, programs, objects, components, and data structures, which perform particular tasks or implement particular abstract data types. The modules 114 and may also be implemented as, signal processor(s), state machine(s), logic circuitries, and/or any other device or component that manipulate signals based on operational instructions. Further, the modules 114 can be implemented by one or more hardware components, by computer-readable instructions executed by a processing unit, or by a combination thereof.

In one implementation, the modules 114 further include a document pre-processor 118, topic generator 120, label generator 122, similarity modeler 124, relationship modeler 126, cluster generator 128, summarizer 130, classifier 132 and other module(s). The other modules may perform various miscellaneous functionalities of the TCAA system 102. It will be appreciated that such aforementioned modules may be represented as a single module or a combination of different modules.

In one example, the data 116 serves, amongst other things, as a repository for storing data fetched, processed, received and generated by one or more of the modules 114. In one implementation, the data 116 may include, for example, processing rules 134, related idea list 136, and other data. In one embodiment, the data 116 may be stored in the memory 110 in the form of various data structures. Additionally, the aforementioned data can be organized using data models, such as relational or hierarchical data models. The other data may be used to store data, including temporary data and temporary files, generated by the modules 114 for performing the various functions of the TCAA system 102.

In operation, the document pre-processor 118 receives documents from one or more data sources 138. In one example, the document pre-processor 118 may facilitate the user to input one or more documents by generating a suitable user interface for the same. In another example, the document pre-processor 118 may implement various techniques to search for documents available in a network. For example, the document pre-processor 118 may scan all the hard-drives and network storage spaces of the marketing division of the organization to search for documents which are to be processed. In another example, the document pre-processor 118 may be configured to fetch documents from various sources, such as blogs, posts on social networking sites, whitepapers available over the Internet, tweets, articles available on websites (including news websites) in the form of webpages, and Rich Site Summary (RSS) feeds. The documents, fetched by the document pre-processor 118, may be structured document or unstructured document and may include, in addition to text, multimedia content, such as images, audio, video, flash and so on.

In one example, the document pre-processor 118 then pre-processes the fetched documents. In some embodiments, the document pre-processor 118 pre-processes the documents to remove noise. In one implementation, the pre-processing of documents may involve removal of infrequent words which occur below a pre-defined threshold number of times, removal of stop-words, and stemming, which reducing inflected or derived words to their stem, base or root form.

The topic generator 120 then analyzes the pre-processed documents to extract the theme of each of the documents based on various pre-defined processing rules, such as the probability and distribution of words and phrases within the documents and so on. In one example, the topic generator 120 may parameterize the technique of extracting themes so that the user may provide values which may be used to control the probability value to view the range of word deviation and visualize the word distribution drift. In some embodiments, the topic generator 120 may create topic models are created on the completion of generation of the topics and its features. The generated topic models are thereafter added to knowledge models. In one example, the topic generator 120 may use the knowledge models to predict distribution of related topics and words in newer documents.

In a subsequent operation, the label generator 122 performs labelling of the documents, based on pre-defined labeling rules, by assigning a topic to each of the documents. In certain cases, a single document may be assigned multiple topics. For example, a document on cricket matches may be tagged with topics, such as sports, games, and names of the teams, players, coaches, and venues. In some embodiments, the label generator 122 may apply various rules of grammar and conventionally known word co-occurrences algorithm (such as Rapid Automatic Keyword Extraction algorithm (RAKE), and Key Phrase Extraction Algorithm (KEA)) to perform labeling of the documents. This facilitates the label generator 122 to assign meaningful names to the topics based on above rules to enable user to identify the relevant topics easily.

In one example, the label generator 122 may also perform trend analysis of the documents. For example, the label generator 122 may obtain the list of generated topics as input, and select the topics with highest distribution for trend analysis. In some embodiments, the label generator 122 may provide a weightage parameter to each words present in each of the topics. Thereafter, the words which have higher weightage parameter and occur with a higher frequency may be projected as a trending idea. For example, if the cluster of documents under a topic is more about mobile technologies then the highest weightage word in the topic will be related to mobility such as name of models pf mobile phones, names of operating system of mobile phones and so on. The trend analysis facilitates the stakeholders to identify topics which are of interest to the users and are often referred to as “hot topics”. The trend analysis also facilitates the stakeholders to identify opportunities or risks of the organization based on the issues or objects in which the users are interested in.

Thereafter, the cluster generator 128 clusters the labelled documents into generic clusters based on pre-defined knowledge & learning models. The pre-defined knowledge & learning models are indicative of the topics which are related, and provide the basis on which related topics are identified. In one example, a document may be clustered into more than one generic cluster.

Thereafter, the relationship modeler 126 determines relationships amongst the labelled documents based on pre-defined relationship models. In one example, the relationship modeler 126 applies relationship modeling on each of the generic clusters for finding unique, related and similar ideas. In operations, the relationship modeler 126 extracts key phrases from each document in each of the generic clusters. The similarity modeler 124 analyzes the key phrases and determines relationships between ideas using a combination of custom and semantic based similarity algorithms. Based on the relationships, the relationship modeler 126 generates related, similar and unique ideas for each generic cluster. The relationship modeler 126 also facilitates collaboration between contributing users to further develop one or more of the ideas. In one example, the relationship modeler 126 may store the related ideas in the generic clusters as related idea list 136 and may publish the same on any collaboration tools, such as discussion forums and blogs, to facilitate contributing users to further develop or refine the related ideas.

In one example, the classifier 132 also processes the relationship(s) and the labelled documents, based on business rules, to determine business relevant ideas. In one example, the classifier 132 may identify the documents which focus on topics which represent opportunities or threats to the organization as business relevant ideas.

In some embodiments, the summarizer 130 may also process the labeled documents to generate an abstract for the labelled documents. In one example, the summarizer 130 may identify a few of the most relevant sentences or phrases in the document and paraphrase the same to generate an abstract for the document. In one example, the summarizer 130 may determine the most significant sentences or phrases in the document based on the distribution of words and phrases and paraphrase the significant sentences as the abstract of the document. In another example, the summarizer 130 may compute the importance of words of the document using various scoring techniques and then combine the scores to classify a word as important or not important. The summarizer 130 may then identify significant sentences of the document based on the important words that a sentence contains and select significant sentences as an abstract of the document. In yet another example, the summarizer 130 may use term frequency, inverse document frequency and stack decoding techniques to extract the relevant sentences from the documents and generate an abstract based on the relevant sentences.

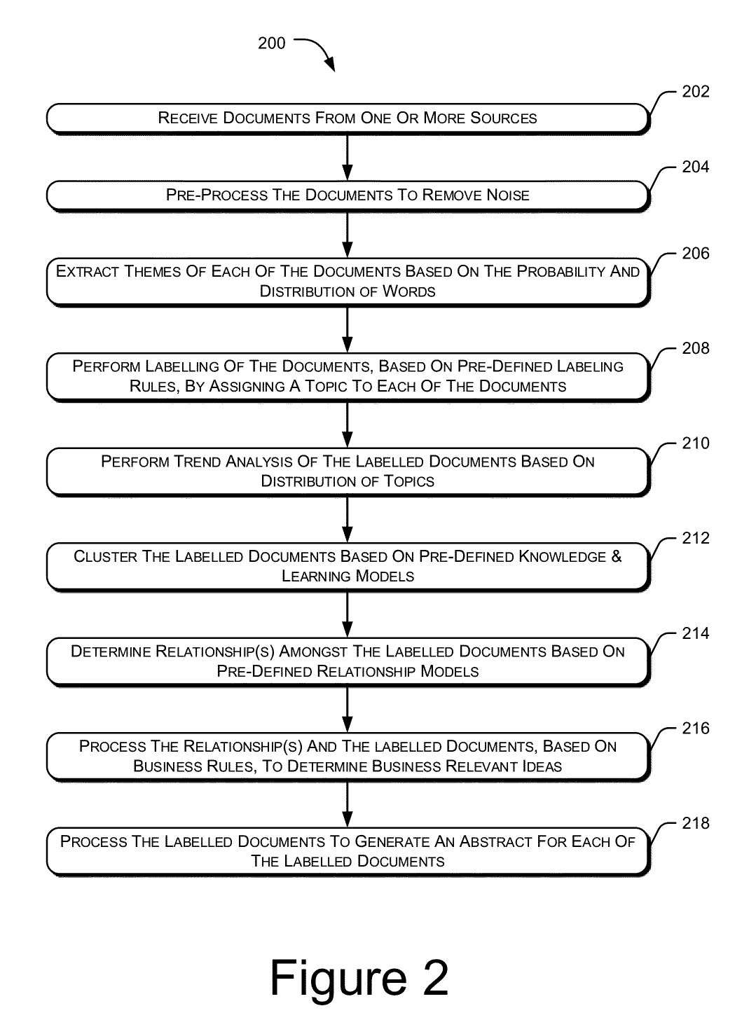

Thus, the TCAA system 102 implements an integrated system to capture and analyze documents to extract ideas present in the documents. The TCAA system 102 may be implemented within an organization or on the internet for crowd sourced ideas. The TCAA system 102 also facilitates discovering ideas relevant to business of the organization and connecting the related ideas and people to further develop or refine the ideas. The detailed working of the TCAA system 102 is further explained in conjunction with the FIGS. 2-4.

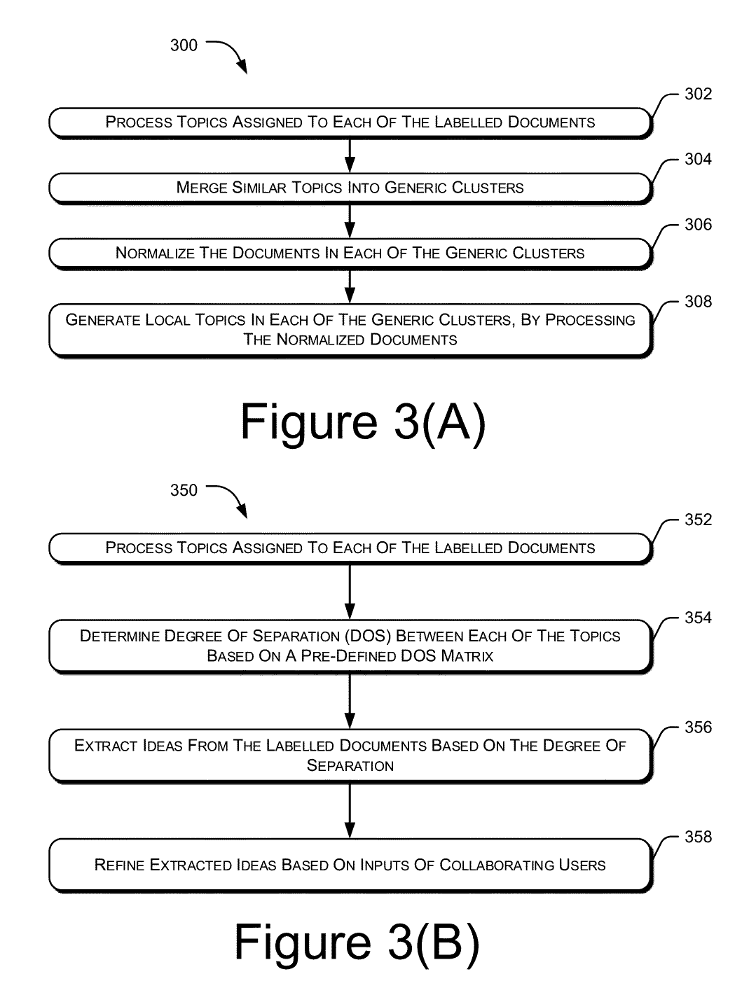

FIG. 2 illustrates an exemplary computer implemented method 200 for capturing and analyzing documents to identify ideas in the documents, according to an embodiment of the present subject matter. FIG. 3(A) and FIG. 3(B) illustrate exemplary sub-processes (henceforth referred to as methods) 300, and 350 associated with the exemplary computer implemented method 200 for capturing and analyzing documents to identify ideas in the documents, according to some embodiments of the present subject matter.

The methods 200, 300, and 350 may be described in the general context of computer executable instructions. Generally, computer executable instructions can include routines, programs, objects, components, data structures, procedures, modules, and functions, which perform particular functions or implement particular abstract data types. The methods 200, 300, and 350 may also be practiced in a distributed computing environment where functions are performed by remote processing devices that are linked through a communication network. In a distributed computing environment, computer executable instructions may be located in both local and remote computer storage media, including memory storage devices.

The order in which the methods 200, 300, and 350 are described is not intended to be construed as a limitation, and any number of the described method blocks can be combined in any order to implement the methods 200, 300, and 350 or alternative methods. Additionally, individual blocks may be deleted from the method 200 without departing from the spirit and scope of the subject matter described herein. Furthermore, the methods 200, 300, and 350 can be implemented in any suitable hardware, software, firmware, or combination thereof.

With reference to method 200 as depicted in FIG. 2, as shown in block 202, documents are received from one or more sources. In one example, the document pre-processor 118 may facilitate the user to input one or more documents by generating a suitable user interface for the same. In another example, the document pre-processor 118 may implement various techniques to search for documents available in a network. For example, the document pre-processor 118 may scan all the hard-drives and network storage spaces of the marketing division of the organization to search for documents which are to be processed. In another example, the document pre-processor 118 may be configured to fetch documents from various sources, such as blogs, posts on social networking sites, whitepapers available over the Internet, tweets, articles available on websites (including news websites) in the form of webpages, and Rich Site Summary (RSS) feeds. The documents, fetched by the document pre-processor 118, may be structured document or unstructured document and may include, in addition to text, multimedia content, such as images, audio, video, flash and so on.

As depicted in block 204, the documents are pre-processed to remove noise. In some embodiments, the document pre-processor 118 pre-processes the documents to remove noise. In one implementation, the pre-processing of documents may involve removal of infrequent words which occur below a pre-defined threshold number of times, removal of stop-words, and stemming, which reducing inflected or derived words to their stem, base or root form.

At block 206, themes of each of the documents are extracted based on the probability and distribution of words. In one example, topic generator 120 then analyzes the pre-processed documents to extract the theme of each of the documents based on various pre-defined processing rules, such as the probability and distribution of words and phrases within the documents and so on.

As illustrated in block 208, labelling of the documents is performed, based on pre-defined labeling rules, by assigning a topic to each of the documents. In one example, the label generator 122 performs labelling of the documents, based on pre-defined labeling rules, by assigning a topic to each of the documents. In certain cases, a single document may be assigned multiple topics. In some embodiments, the label generator 122 may apply various rules of grammar and conventionally known word co-occurrences algorithm to perform labelling of the documents.

As shown in block 210, trend analysis of the labelled documents is performed based on distribution of topics. In one example, the label generator 122 may obtain the list of generated topics as input, and select the topics with highest distribution for trend analysis.

As depicted in block 212, the labelled documents are clustered based on pre-defined knowledge & learning models. In one example, the cluster generator 128 clusters the labelled documents into generic clusters based on pre-defined knowledge & learning models. The pre-defined knowledge & learning models are indicative of the topics which are related, and provide the basis on which related topics are identified. In one example, a document may be clustered into more than one generic cluster.

At block 214, relationship(s) amongst the labelled documents are determined based on pre-defined relationship models. In one example, the relationship modeler 126 determines relationships amongst the labelled documents based on pre-defined relationship models. In one example, the relationship modeler 126 applies relationship modeling on each of the generic clusters for finding unique, related and similar ideas. In operations, the relationship modeler 126 extracts key phrases from each document in each of the generic clusters. The similarity modeler 124 analyzes the key phrases and determines relationships between ideas using a combination of custom and semantic based similarity algorithms. Based on the relationships, the relationship modeler 126 generates related, similar and unique ideas for each generic cluster.

As illustrated in block 216, the relationship(s) and the labelled documents are processed, based on business rules, to determine business relevant ideas. In one example, the classifier 132 also processes the relationship(s) and the labelled documents, based on business rules, to determine business relevant ideas. In one example, the classifier 132 may identify the documents which focus on topics which represent opportunities or threats to the organization as business relevant ideas.

As depicted in block 218, the labelled documents are processed to generate an abstract for each of the labelled documents. In one example, the summarizer 130 may identify a few of the most relevant sentences or phrases in the document and paraphrase the same to generate an abstract for the document. In one example, the summarizer 130 may determine the most significant sentences or phrases in the document based on the distribution of words and phrases and paraphrase the significant sentences as the abstract of the document.

With reference to method 300 as depicted in FIG. 3(A), as shown in block 302, topics assigned to each of the labelled documents are processed. In one example, the cluster generator 128 processes the topics assigned to each of the labelled documents to determine the significant words or the keywords in the topics.

As illustrated in block 304, documents of similar topics are merged into generic clusters. In one example, the cluster generator 128 clusters the labelled documents into generic clusters based on pre-defined knowledge & learning models. The pre-defined knowledge & learning models are indicative of the topics which are related, and provide the basis on which related topics are identified. In one example, a document may be clustered into more than one generic cluster.

As depicted in block 306, the documents, in each of the generic clusters, are normalized. In one example, the topic generator 128 normalizes the documents in each of the generic clusters. In one example, the normalization process involves calculating the mean of topic distribution of all documents in a particular cluster and dividing individual topic distribution of each document by this mean to convert all distribution value to a common scale.

At block 308, local topics are generated in each of the generic clusters, by processing the normalized documents. In one example, the topic generator 128 further processes the documents in the generic clusters to determine local topics or sub topics within the topic of the generic cluster.

With reference to method 350 as depicted in FIG. 3(B), as shown in block 352, topics assigned to each of the labelled documents are processed. In one example, the cluster generator 128 processes the topics assigned to each of the labelled documents to determine the significant words or the keywords in the topics.

As illustrated in block 354, degree of separation (DOS) between each of the topics is determined based on a pre-defined DOS matrix. In one example, the cluster generator 128 generates a DOS matrix. In another example, the cluster generator 128 receives a pre-defined DOS matrix from the user. Based on the pre-defined DOS matrix, the cluster generator 128 determines a degree of separation between each of the topics.

As depicted in block 356, ideas are extracted from the labelled documents based on the degree of separation. In one example, the cluster generator 128 extracts ideas from the labelled documents based on the degree of separation.

At block 358, extracted ideas are refined based on inputs of collaborating users. In one example, the relationship modeler 126 may publish the extracted ideas on any collaboration tools, such as discussion forums and blogs, to facilitate contributing users to further develop or refine the related ideas.

### Computer System:

FIG. 3 is a block diagram of an exemplary computer system for implementing embodiments consistent with the present disclosure. Variations of computer system 301 may be used for implementing any of the devices presented in this disclosure. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 318-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol); secure sockets layer (SSL), Transport Layer Security (TLS), etc. Web browsers may utilize facilities such as AJAX, DHTML, Adobe Flash, JavaScript, Java; application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObj ects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a method and a system for capturing and analyzing documents to identify ideas in the documents. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for capturing and analyzing documents to identify ideas in the documents, the method comprising:
pre-processing, by a topic capture and analysis computing device, the documents to remove noise;
extracting, by the topic capture and analysis computing device, a theme associated with each of the documents, based on a distribution of words and phrases in the documents;
labelling, by the topic capture and analysis computing device, the documents by assigning a topic to each of the documents, based on one or more pre-defined labelling rules and the theme associated with each of the documents; and
clustering, by the topic capture and analysis computing device, the labelled documents into a plurality of groups based on similarity of the topics assigned to each of the documents.

2. The method as set forth in claim 1, further comprising:
determining, by the topic capture and analysis computing device, relationships between the labelled documents based on one or more pre-defined relationship models; and
processing, by the topic capture and analysis computing device, the determined relationships and the labelled documents to determine one or more business relevant ideas.

3. The method as set forth in claim 1, further comprising:
processing, by the topic capture and analysis computing device, the labelled documents to generate an abstract for each of the labelled documents.

4. The method as set forth in in claim 1, further comprising:
performing, by the topic capture and analysis computing device, a trend analysis on the labelled documents, based on a distribution of the topics; and
determining, by the topic capture and analysis computing device, one or more topics which are trending in the documents, based on the trend analysis.

5. The method as set forth in claim 1, further comprising:
processing, by the topic capture and analysis computing device, the topics assigned to each of the labelled documents;
merging, by the topic capture and analysis computing device, the labelled documents into one or more generic clusters based on a similarity of the topics associated with each of the labelled documents;
normalizing, by the topic capture and analysis computing device, the labelled documents in at least one of the one or more generic clusters; and
generating, by the topic capture and analysis computing device, one or more local topics in the at least one of the one or more generic clusters, by processing the normalized documents.

6. The method as set forth in claim 1, further comprising:
processing, by the topic capture and analysis computing device, the topics assigned to each of the labelled documents;
generating, by the topic capture and analysis computing device, a degree of separation matrix;
determining, by the topic capture and analysis computing device, a degree of separation between each of the topics based on the degree of separation matrix;
extracting, by the topic capture and analysis computing device, one or more ideas from the labelled documents based on the degree of separation matrix; and
refining, by the topic capture and analysis computing device, based on one or more requirements specified by one or more business rules, extracted ideas based on one or more inputs of collaborating users.

7. A topic capture and analysis computing device comprising:
a processor coupled to a memory and configured to execute programmed instructions stored in the memory, comprising:
pre-processing one or more documents to remove noise;
extracting a theme associated with each of the documents, based on a distribution of words and phrases in the documents;
labelling the documents by assigning a topic to each of the documents, based on one or more pre-defined labelling rules and the theme associated with each of the documents; and
clustering the labelled documents into a plurality of groups based on similarity of the topics assigned to each of the documents.

8. The device as set forth in claim 7 wherein the processor is further configured to execute programmed instructions stored in the memory further comprising:
determining relationships between the labelled documents based on one or more pre-defined relationship models; and
processing the determined relationships and the labelled documents to determine one or more business relevant ideas.

9. The device as set forth in claim 7 wherein the processor is further configured to execute programmed instructions stored in the memory further comprising:
processing the labelled documents to generate an abstract for each of the labelled documents.

10. The device as set forth in in claim 7 wherein the processor is further configured to execute programmed instructions stored in the memory further comprising:
performing a trend analysis on the labelled documents, based on a distribution of the topics; and
determining one or more topics which are trending in the documents, based on the trend analysis.

11. The device as set forth in claim 7 wherein the processor is further configured to execute programmed instructions stored in the memory further comprising:
processing the topics assigned to each of the labelled documents;
merging the labelled documents into one or more generic clusters based on a similarity of the topics associated with each of the labelled documents;
normalizing the labelled documents in at least one of the one or more generic clusters; and
generating one or more local topics in the at least one of the one or more generic clusters, by processing the normalized documents.

12. The device as set forth in claim 7 wherein the processor is further configured to execute programmed instructions stored in the memory further comprising:
processing the topics assigned to each of the labelled documents;
generating a degree of separation matrix;
determining a degree of separation between each of the topics based on the degree of separation matrix;
extracting one or more ideas from the labelled documents based on the degree of separation matrix; and
refining, based on one or more requirements specified by one or more business rules, extracted ideas based on one or more inputs of collaborating users.

13. A non-transitory computer readable medium having stored thereon instructions for capturing and analyzing documents to identify ideas in the documents comprising machine executable code which when executed by a processor, causes the processor to perform steps comprising:
pre-processing one or more documents to remove noise;
extracting a theme associated with each of the documents, based on a distribution of words and phrases in the documents;
labelling the documents by assigning a topic to each of the documents, based on one or more pre-defined labelling rules and the theme associated with each of the documents; and
clustering the labelled documents into a plurality of groups based on similarity of the topics assigned to each of the documents.

14. The medium as set forth in claim 13 wherein the medium further comprises machine executable code which, when executed by the processor, causes the processor to perform steps further comprising:
determining relationships between the labelled documents based on one or more pre-defined relationship models; and
processing the determined relationships and the labelled documents to determine one or more business relevant ideas.

15. The medium as set forth in claim 13 wherein the medium further comprises machine executable code which, when executed by the processor, causes the processor to perform steps further comprising:
processing the labelled documents to generate an abstract for each of the labelled documents.

16. The medium as set forth in claim 13 wherein the medium further comprises machine executable code which, when executed by the processor, causes the processor to perform steps further comprising:
performing a trend analysis on the labelled documents, based on a distribution of the topics; and
determining one or more topics which are trending in the documents, based on the trend analysis.

17. The medium as set forth in claim 13 wherein the medium further comprises machine executable code which, when executed by the processor, causes the processor to perform steps further comprising:
processing the topics assigned to each of the labelled documents;
merging the labelled documents into one or more generic clusters based on a similarity of the topics associated with each of the labelled documents;
normalizing the labelled documents in at least one of the one or more generic clusters; and
generating one or more local topics in the at least one of the one or more generic clusters, by processing the normalized documents.

18. The medium as set forth in claim 13 wherein the medium further comprises machine executable code which, when executed by the processor, causes the processor to perform steps further comprising:
processing the topics assigned to each of the labelled documents;
generating a degree of separation matrix;
determining a degree of separation between each of the topics based on the degree of separation matrix;
extracting one or more ideas from the labelled documents based on the degree of separation matrix; and
refining, based on one or more requirements specified by one or more business rules, extracted ideas based on one or more inputs of collaborating users.
